(19) United States
(12) Patent Application Publication
(10) Pub. No.: US 2005/0138346 A1
(43) Pub. Date: Jun. 23, 2005

(54) iSCSI boot drive system and method for a scalable internet engine

(76) Inventor: David M. Cauthron, Tomball, TX (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/929,737

(22) Filed: Aug. 30, 2004

Related U.S. Application Data
(60) Provisional application No. 60/498,460, filed on Aug. 28, 2003.
(60) Provisional application No. 60/498,447, filed on Aug. 28, 2003.
(60) Provisional application No. 60/498,493, filed on Aug. 28, 2003.

(51) Int. Cl. G06F 9/00

(52) U.S. Cl. 713/2

(57) ABSTRACT

A system for remote booting of a server generally includes a client initiator, an iSCSI virtualizer, and an iSCSI initiator. The client initiator requests access to the server and the iSCSI virtualizer receives the access request. Then, the iSCSI initiator acts upon the request received by the iSCSI virtualizer to initiate login to the server through use of an iSCSI Boot ROM on the server and to emulate a disk operating system through use of the iSCSI Boot ROM, which enables the server to boot. The server boots in both an 8-bit and a subsequent 32-bit mode. The iSCSI Boot ROM appears as a local device upon the completion of the server boot. The iSCSI virtualizer authenticates the login at least twice. The iSCSI virtualizer includes a pair of replicated active directory service servers (ADSS).

### PRIORITY CLAIM

The present application claims priority to U.S. Provisional Application No. 60/498,460 entitled, “iSCSI BOOT DRIVE SYSTEM AND METHOD FOR A SCALABLE INTERNET ENGINE,” filed Aug. 28, 2003; U.S. Provisional Application No. 60/498,447 entitled “MAINTENANCE UNIT ARCHITECTURE FOR A SCALABLE INTERNET ENGINE,” filed Aug. 28, 2003; and U.S. Provisional Application No. 60/498,493 entitled “COMPUTING HOUSING FOR BLADE WITH NETWORK SWITCH,” filed Aug. 28, 2003 the disclosures of which are hereby incorporated by reference. Additionally, the present application incorporates by reference U.S. patent application Ser. No. 09/710,095 entitled “METHOD AND SYSTEM FOR PROVIDING DYNAMIC HOSTED SERVICE MANAGEMENT ACROSS DISPARATE ACCOUNTS/SITES,” filed Nov. 10, 2000.

### FIELD OF THE INVENTION

The present invention is related to remote booting of a server and, more particularly, to the remote booting of a server through the use of an iSCSI boot drive.

### BACKGROUND OF THE INVENTION

A computer or computer system, when turned on, must be prepared for operation by loading an operating system. In the normal operation of a single computer system, when a user issues a boot command to the computer, the computer responds to the boot command by attempting to retrieve the operating system files from the computer systems memory. Configuration data files are also needed to configure the specific machine with the hardware parameters necessary for the specific hardware configuration. These files also contain information needed to initialize videos, printers, and peripherals associated with the particular machine. For example, the files would include CONFIG.SYS in the MS-DOS operating system, available from Microsoft® Corporation.

Computers or computer systems can be connected in a network normally consisting of a client workstation, a server and a central network. In a system where the computer's storage is maintained when the power is turned off, the operating system can be stored in the computer itself. In a system where the computer has only storage that is lost when the power is turned off, the computer cannot retrieve the boot information from within the computer itself. In that case, the client sends a request for the operating system files via the network to the server acting as a boot server. Even when the client workstation has non-volatile storage capability, it is advantageous to boot from the server because memory space is saved in the workstation computer. As operating system and application programs expand to provide new and greater capabilities, booting from a server can be highly advantageous.

Several methods of remote booting exist in the marketplace. One is called Remote Initial Program Load (RIPL). RIPL is the process of loading an operating system onto a workstation from a remote location. The RIPL protocol was co-developed by 3Com, Microsoft®, and IBM®. It is used today with IBM® OS/2 Warp Server, DECO Pathworks, and Windows® NT. Two other commonly used Remote IPL protocols are a Novell® NCP (NetWare Core Protocol), and BOOT-P, an IEEE standard, used with UNIX and TCP/IP networks.

RIPL is achieved using a combination of hardware and software. The requesting device, called the requester or workstation, starts up by asking the loading device to send it a bootstrap program. The loading device is another computer that has a hard disk and is called the RIPL server or file server. The RIPL server uses a loader program to send the bootstrap program to the workstation. Once the workstation receives the bootstrap program, it is then equipped to request an operating system, which in turn can request and use application programs. The software implementations differ between vendors, but theoretically, they all perform similar functions and go through a similar process. The client workstation requires a special Read Only Memory (ROM) installed on its (Local Area Network) LAN adapter or Network Interface Card (NIC). The special ROM is known generally as a remote boot ROM, but two specific examples of remote boot chips are the RIPL chip, which supports ANSI/IEEE standard 802.2, and the Preboot Execution Environment (PXE) chip, which is used in the Transmission Control Protocol/Internet Protocol (TCP/IP) environment.

Still another method of remote booting is described in U.S. Pat. No. 6,487,601. This method for dynamic MAC allocation and configuration is based on the ability to remotely boot a client machine from a server machine and adds the capability to assign a Locally Administered Address (LAA) to override the Universally Administered Address (UAA). A set of programs at the workstation allows a remote boot and interaction with the server. The client machine will send out a DMAC discovery frame. The discovery frame will be intercepted by a DMAC program installed on the server which will be running and listening for the request. Once the DMAC program intercepts the request it analyzes the request and takes one of two actions. If necessary, the server will run an “initialization” script. For workstations that have already been initialized, the server will send an LAA to the client workstation from a table or pool. The client workstation will then request an operating system with its new LAA. The boot options will be a table or pool corresponding to an LAA or range of LAA's. In order to achieve the override of the UAA, the DMAC will assign an LAA to the workstation. Once the LAA is assigned the boot will proceed based on the package that will be shipped to that address.

The internet SCSI (iSCSI) protocol defines a means to enable block storage applications over TCP/IP networks. The SCSI architecture is based on a client/server model, and iSCSI takes this into account to deliver storage functionality over TCP/IP networks. The client is typically a host system such as a file server that issues requests to read or write data. The server is a resource such as a disk array that responds to client requests. In storage parlance, the client is an initiator and plays the active role in issuing commands. The server is target and has a passive role in fulfilling client requests, having one or more logical units that process initiator commands. Logical units are assigned identifying numbers, or logical unit numbers (LUNs).

The commands processed by a logical unit are contained in a Command Descriptor Block (CDB) issued by the host system. A CDB sent to a specific logical unit, for example, might be a command to read a specified number of data blocks. The target's logical unit would begin the transfer of the requested blocks to the initiator, terminating with a status to indicate completion of the request. The central mission of iSCSI is to encapsulate and reliably deliver CDB transaction between initiators and targets over TCP/IP networks.

### SUMMARY OF THE INVENTION

The present invention is a system and method for remote booting of a server. The system generally includes a client initiator, an iSCSI virtualizer, and an iSCSI initiator. The client initiator requests access to the server and the iSCSI virtualizer receives the access request. Then, the iSCSI initiator acts upon the request received by the iSCSI virtualizer to initiate login to the server through use of an iSCSI Boot ROM on the server and to emulate a disk operating system through use of the iSCSI Boot ROM, which enables the server to boot.

The server boots in both an 8-bit and a subsequent 32-bit mode. The iSCSI Boot ROM appears as a local device upon the completion of the server boot. The iSCSI virtualizer authenticates the login at least twice. The iSCSI virtualizer includes a pair of replicated active directory service servers (ADSS).

The method for remote booting of a server of the present invention includes the following steps: 1) Receiving a request from an initiator to access the server; 2) Initiating a boot of the server by powering on the server based upon the request; 3) Intercepting the initiated boot process with an iSCSI Boot ROM; 4) Emulating a disk operating system with the iSCSI Boot ROM; and 5) Enabling the server to boot completely based upon the emulation of the disk operating system.

### BRIEF DESCRIPTION OF THE DRAWINGS

FIG. 1 is a block diagram depicting a simplified scalable internet engine with replicated servers that utilizes the iSCSI boot drive of the present invention.

FIG. 2 is a flowchart depicting the activation/operation of the iSCSI boot drive of the present invention.

FIG. 3 is a block diagram depicting is a server farm established in accordance with the present invention.

### DETAILED DESCRIPTION OF THE PREFERRED EMBODIMENTS

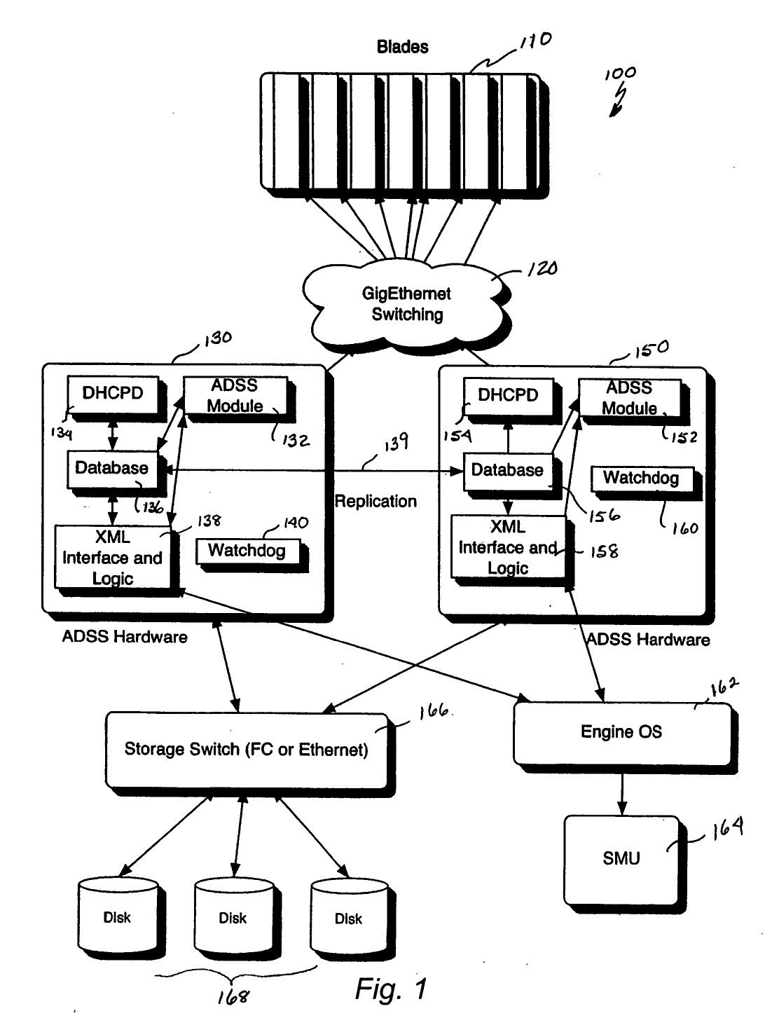

Referring to FIG. 1, an architecture 100 for a scalable internet engine is defined by a plurality of server boards each arranged as an engine blade 110. Further details as to the scalability of the internet engine are provided in U.S. Pat. No. 6,452,809, entitled “Scalable Internet Engine,” which is hereby incorporated by reference. The architecture is further defined by a set of hardware 130 that establishes the active data storage system (ADSS) including an ADSS module 132, a domain host control protocol server (DHCPD) 134, a database 136, an XML interface 138 and a watchdog timer 140. Hardware 130 is replicated by the hardware 150, which includes an ADSS module 152, a domain host control protocol server (DHCPD) 154, a database 156, an XML interface and a watchdog timer 160. Both ADSS hardware 130 and ADSS hardware 150 are interfaced to the blades 110 via an Ethernet switching device 120. Combined, ADSS hardware 130 and ADSS hardware 150 may be deemed a virtualizer, a system capable of virtual volumes to an initiator (e.g., client, host system, or file server that requests a read or write of data).

The architecture 100 is still further defined by an engine operating system (OS) 162, which is operatively coupled between hardware 130, 150 and a system management unit (SMU) 164 and by a storage switch 166, which is operatively coupled between hardware 130, 150 and a plurality of storage disks 168.

The ADSS modules 132 and 152 provide a directory service for distributed computing environments and present applications with a single, simplified set of interfaces so that users can locate and utilize directory resources from a variety of networks while bypassing differences among proprietary services; it is a centralized and standardized system that automates network management of user data, security, and distributed resources, and enables interoperation with other directories. Further, the active directory service allows users to use a single log-on process to access permitted resources anywhere on the network while network administrators are provided with an intuitive hierarchical view of the network and a single point of administration for all network objects.

The DHCPD 134 and 154 operates to assign unique IP addresses within the server system to devices connected to the architecture 100, e.g., when a computer logs on to the network, the DHCP server selects a unique and unused IP address from a master list and assigns it to the system. The databases 136 and 156, communicatively coupled to their respective ADSS module and DHCPD, serve as the repositories for all target, initiator, volume, and raw storage mapping information as well as serve as the source of information for the DHCPD. The databases are replicated between all ADSS team members so that vital system information is redundant. The XML interface daemons 138 and 158 serve as the interface between the engine operating system 162 and the ADSS hardware 130, 150. They serve to provide logging functions and to provide logic to automate the ADSS functions. The watchdog timers 140 and 160 are provided to reinitiate server operations in the event of a lock-up in the operation of any of the servers, e.g., a watchdog timer time-out indicates failure of the ADSS. The storage switch 166 is preferably of a Fiber Channel or Ethernet type and enables the storage and retrieval of data between disks 168 and ADSS hardware 130, 150.

Note that in the depicted embodiment of architecture 100, ADSS hardware 130 functions as the primary DHCP server unless there is a failure. A heartbeat monitoring circuit, represented as line 139, is incorporated into the architectures between ADSS hardware 130 and ADSS hardware 150 to test for failure. Upon failure of server 130, server 150 will detect the lack of the heartbeat response and will immediately begin serving the DHCP information. In a particularly large environment, the server hardware will see all storage available, such as storage in disks 168, through a Fiber Channel switch so that in the event of a failure of one of the servers, another one of the servers (although only one other is shown here) can assume the functions of the failed server. The DHCPD modules interface directly with the corresponding database as there will be only one database per server for all of the IP and MAC address information of architecture 100.

In this example embodiment, engine operating system interface 164 (or Simple Web-Based interface) issues “action” commands via XML interface daemon 138 or 158, to create, change, or delete virtual volumes. XML interface 138 also issues action commands for assigning/un-assigning or growing/shrinking virtual volume make available to an initiator as well as checkpoint, mirror, copy and migrate commands. The logic portion of the XML interface daemon 138 also receives “action” commands involving: checks for valid actions; converts into server commands; executes server commands; confirms command execution; roll back if failed command; and provides feedback to the engine operating system 162. Engine operating system 162 also issues queries for information through the XML interface 138 with the XML interface 138 checking for valid queries, converting XML queries to database queries, converting responses to XML and sending XML data back to operating system 162, The XML interface 138 also sends alerts to operating system 162, with failure alerts being sent via the log-in server or the SNMP.

Pointedly, the ADSS system of the present invention has a distributed nature. Specifically, the present invention has a distributed virtualization in which any ADSS can service any client blade by virtue of the fact that all ADSS units of the present invention can “see” all client blades and all ADSS units can “see” all RAID storage units where the virtual volumes are stored. In this manner, the client blades can be mapped to any arbitrary ADSS unit on demand for either failover or redistribution of load. ADSS units can then be added to the team at any time to upgrade the combined bandwidth of the total system. Compare the present invention in contrast to a prior art product called SANSymphony™ by Datacore™, which has a fault tolerant pair of storage virtualizers with a simple failover method and no other scaling possibilities.

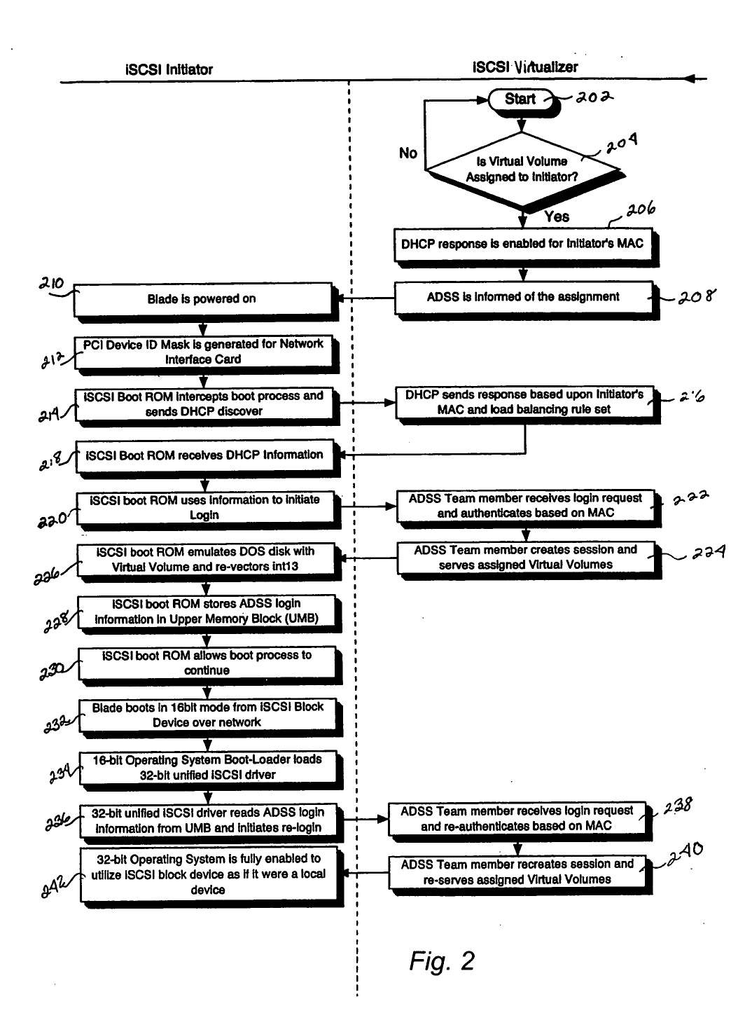

In view of the above description of the scalable internet engine architecture 100, the login process to the scalable internet engine may now be understood with reference to the flow chart of FIG. 2. Login is established through the use of iSCSI bootdrive, wherein the operations enabling the iSCSI bootdrive are divided between an iSCSI virtualizer (ADSS hardware 130 and ADSS hardware 150 comprising the virtualizer), see the right side of the flow chart of FIG. 2, and an iSCSI Initiator, see the left side of the flow chart of FIG. 2. The login starts with a request from an initiator to the iSCSI virtualizer, per start block 202. The iSCSI virtualizer then determines if a virtual volume has been assigned to the requesting initiator, per decision block 204. If a virtual volume has not been assigned, the iSCSI virtualizer awaits a new initiator request. However, if a virtual volume has been assigned to the initiator the login process moves forward whereby the DHCP server 134 response is enabled for the initiator's MAC (medium access control address), per operations block 206. Next, the ADSS module 132 is informed of the assignment of the virtual volume in relation to the MAC, per operations block 208 and communicates to power on the appropriate engine blade 110, per operations block 210 of the iSCSI initiator.

Next, a PCI (peripheral component interconnect) device ID mask is generated for the blade's network interface card thereby initiating a boot request, per operations block 212. Note that a blade is defined by the following characteristics within the database 136: 1) MAC address of NIC (network interface card), which is predefined; 2) IP address of initiator (assigned), including a) Class A Subnet [255.0.0.0] and b) 10.[rack].[chassis].[slot]; and 3) iSCSI authentication fields (assigned) including: a) pushed through DHCP; and b) initiator name. The term “pushed through DHCP” refers to the fact that all iSCSI authentication fields are pushed to the client initiator over DHCP. To clarify, all prior art iSCSI implementations require that authentication information such as username, password, IP address of the iSCSI target which will be serving the volume, etc., be manually entered into the clients console through operating system utility software. This is one of the primary reasons why prior art iSCSI implementations are not capable of booting because this information is not available until an operating system and respective iSCSI software drivers have loaded and either read preset parameters or had manual intervention from the operator to enter this information.

The traditional use for the Dynamic Host Configuration Protocol (DHCP) is to assign an IP address to a client from a pool of addresses that are valid on a particular network. Normally these addresses are doled out on a random basis, where a client looks for a DHCP server through means of an IP address-less broadcast and the DHCP responds by “leasing” a valid IP address to the client from its address pool. In the present invention, a specialized DHCP server has been created that assigns specific IP addresses to the blade clients by correlating IP addresses with MAC addresses (the physical, unchangeable address of the Ethernet network interface card) thereby guaranteeing that the blade client IP addresses are always the same since their MAC addresses are consistent. The IP address to MAC correlations is generated arbitrarily during the initial configuration of the ADSS, but remains consistent after this time. Additionally, we utilized special extended fields in the DHCP standard to send additional information to the blade client which defines the iSCSI parameters necessary for it to find the ADSS that will service the blade's disk requests and the authentication necessary to log into the ADSS.

By pushing this information through the DHCP, the present invention not only provides a method to make this information available to the client initiator at the pre-OS stage of the boot process, but the present invention can also create a central authority, the ADSS, which can store and dynamically change these settings to facilitate operations like failing over to an alternative ADSS unit or adding or changing the number and size of virtual disks mounted on the client without any intervention from the client's point of view.

Continuing now with the process from FIG. 2, the iSCSI Boot ROM, intercepts the boot process and sends a discover request to the DHCP SERVER 134, per operations block 214. Note that in the blade architecture of the present invention, the PCI-X bus of a blade motherboard is passed through the midplane and to PCI-X slots on the rear of the chassis. This is accomplished through the systems management board which utilizes a PCI bridge chip to condition and regenerate the PCI signals. This bridge chip also enables the system to tap into the PCI-X bus within the management board and it is there in which the iSCSI boot ROM is located. As mentioned the iSCSI boot ROM sits on the PCI-X bus of the motherboard. Intel compatible motherboard architectures, when booted, are controlled by the motherboard's BIOS chip. Part of the boot process, however is to seek out what is called option ROMs or ROM extensions that sit on the PCI-X bus. At a certain point in the boot process, the motherboard BIOS hands control over to the ROM extension and the ROM extension can then execute its code. In the present invention, this is the point at which time the TCP/IP stack and iSCSI initiator are loaded up, and the emulation process, i.e., the process whereby an iSCSI block device (virtual volume) appears to be a local disk on the client, begins.

This works in much the same way that a SCSI card intercepts the boot process and allows the system to boot from a SCSI device. ROM extensions are for the express purpose of extending the capabilities of the motherboard in the pre-boot environment usually to enable a device which the motherboard BIOS does not understand natively.

After the discover request, the DHCP server sends a response to the discover request based upon the initiator's MAC and load balancing rule set, per operations block 216. Specifically, the DHCP server 134 sends the client's IP address, netmask and gateway, as well as iSCSI login information: 1) the server's IP address (ADSS's IP); 2) protocol (TCP by default); 3) port number (3260 by default); 4) initial LUN (logical unit number); 5) target name, i.e., ADSS server's iSCSI target name; and 6) initiator's name.

The load balancing rule set mentioned immediately above refers to distributing virtual volume servicing duties among the various ADSS units. The architecture of the ADSS system involves both of the two master ADSS servers which provide the DHCP, database, and management resources, and are configured as a cluster for fault tolerance of the vital database information and DHCP services. Also included is a number of “slave” ADSS workers which are connected to and are controlled by the master ADSS server pair. These ADSS units simply service virtual volumes. Load balancing is achieved by distributing virtual volume servicing duties among the various ADSS units through a round robin with least connections priority model in which the ADSS serving the least number of clients is first in line to service new clients. Class of service is also achieved through imposing caps on the maximum number of clients that any one ADSS can service thereby creating more storage bandwidth for the clients who use these capped ADSS units versus those who operate on the standard ADSS pool.

Next, referring once again to FIG. 2, the iSCSI Boot ROM receives the DHCP server 134 information, per operations block 218 and uses the information to initiate login to the blade server, per operations block 220. The ADSS module 132 receives the login request and authenticates the request based upon the MAC of the incoming login and the initiator name, per operations block 222. Next, the ADSS module creates the login session and serves the assigned virtual volumes, per operations block 224. The iSCSI Boot ROM emulates a DOS disk with the virtual volume and re-vectors Int13, per operations block 226. The iSCSI Boot ROM stores ADSS login information in its Upper Memory Block (UMB), per operations block 228. The iSCSI Boot ROM then allows the boot process to continue, per operations block. 230.

As such, the blade boots in 8-bit mode from the iSCSI block device over the network, per operations block 232. The 8-bit operating system boot-loader loads the 32-bit unified iSCSI driver, per operations block 234. The 32-bit unified iSCSI driver reads the ADSS login information from UMB and initiates re-login, per operations block 236. The ADSS module 132 receives the login request and re-authenticates based on the MAC, per operations block 238. Next, the ADSS module recreates the login session and re-serves the assigned virtual volumes, per operations block 240. Finally, the 32-bit operating system is fully enabled to utilize the iSCSI block device as if it were a local device, per operations block 242.

With respect to operations block 226 and the term “re-vectors int13,” the following an explanation provides a background for understanding the operation and function of block 226. Starting with the first IBM® PC computer in 1983 all Intel® compatible computers are equipped with some very fundamental operations which are handled by the Basic Input Output System (BIOS) ROM which is located on the motherboard. Back when hardware was relatively simple all access to the hardware of a computer was mediated through the BIOS using called to interrupts, which when used, interrupt the execution of user code and run BIOS code to accomplish hardware access. Unfortunately, to maintain compatibility this system of interrupts still exists today and still remains a problem that must be worked around in order to run a modern operating system.

Modern operating systems use their own 32 bit drivers to access the hardware directly, however, before these 32 bit drivers function they must be loaded by the legacy BIOS hardware access methods developed in 1983. Interrupt 13 h is the handler for disk services on a PC compatible computer and is what is called to look for a boot sector on a disk in the system. In order to make a PC compatible computer boot off of a device that is not the BIOS supported disk, it is necessary to re-vector Int13 away from the BIOS and to the desired ROM Extension code.

With this redirection of the interrupt, disk calls that were intended for the BIOS get intercepted by the ROM Extension code allowing the ROM Extension to provide disk services instead. The disk services of the ROM Extension, however, are accessing an iSCSI Block Device (virtual volume) and not a local disk drive. When the motherboard BIOS looks for a boot sector on its local disks, it then finds the boot sector of the attached iSCSI block device and begins to execute the code stored there, which is usually the boot-loader process of the OS. The modern OS bootloader (NTLOADER.EXE for Windows® or LILO™ or GRUB™ for Linux®) is then enabled through this redirection or re-vectoring to load all of the 32 bit drivers it needs to directly access the system hardware itself, including the present invention's iSCSI driver which provides 32 bit access to the iSCSI Block Device (virtual volume).

With respect to operations block 236 and the term “UMB,” the following provides an explanation. Again it is necessary to refer to the history of the IBM® PC architecture developed in 1983. The first IBM® PC was an 8-bit computer, which means that the computer's microprocessor was only capable of addressing 1 MB or 1024 KB of memory in total. This includes RAM for executing programs, ROM for storing the BIOS and BIOS extensions, memory locations for device control and Video RAM. The original PC divided this memory into a block from 0-640 KB for RAM and from 640 KB to 1024K as the Upper Memory Blocks (UMMBs) in which all other devices and memory is mapped.

Modern processors have progressed from 8-bit to 16-bit and onwards up to the latest 64-bit processors (capable of accessing much larger amounts of memory as the number of bits increase), but to preserve compatibility with the original 8-bit PC all modern computers still boot in an 8-bit environment that has the same rules and restrictions of the original PC. Therefore the concept of the UMB still exists at the time of booting.

In the present invention's iSCSI boot process, it is started with an 8-bit ROM extension as mentioned above which takes the computer through the initial process but then it is necessary to somehow pass the iSCSI target information and associated parameters to the 32-bit iSCSI driver that is loaded with the OS. The present invention does this by having the iSCSI ROM Extension store this information in an unused UMB (which is mapped to the RAM of the system) for later retrieval by the 32-bit iSCSI driver.

With respect to the term “iSCSI block device” used above, the following explanation is provided. An iSCSI block device refers to the disk or virtual volume that is made available over the iSCSI connection. The reason the term block device is used is to differentiate it from a standard network file system. SCSI drives are made up of sectors arranged into blocks which are read by issuing SCSI commands to either read or write these blocks (and is therefore a more “raw” method of accessing data) unlike a network share which operates on a file system level where requests are made for files and directories and is dependant of OS compatibility. Since the present invention utilizes block level access over iSCSI, the present invention can essentially support any OS that is compatible with SCSI.

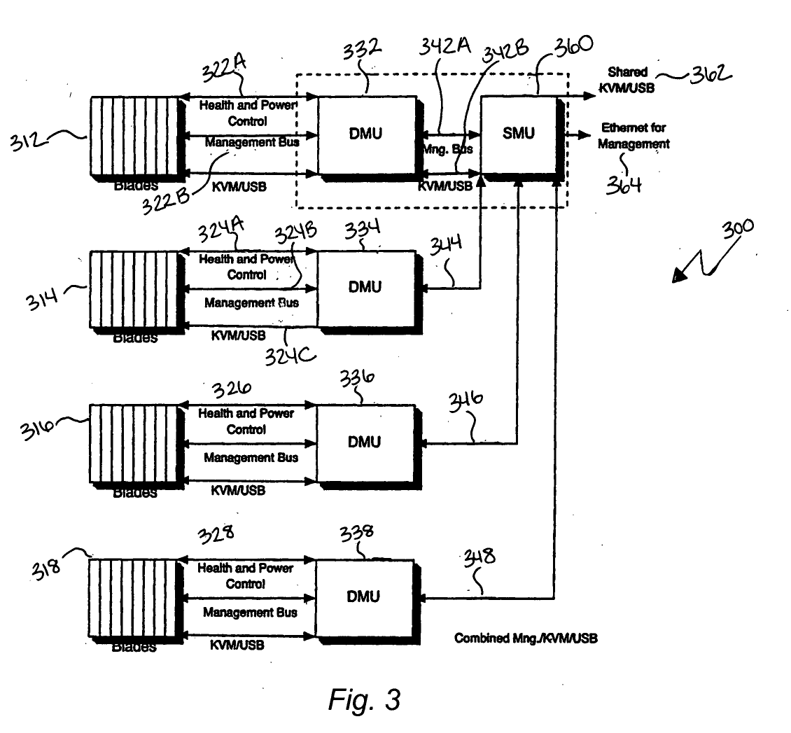

Referring now to FIG. 3, there is illustrated a supervisory data management arrangement 300 adapted to form part of architecture 100. Supervisory data management arrangement 300 comprises a plurality of blade servers 312-318 that interface with a plurality of distributed management units (DMUs) 332-338, which in turn interface with at least one supervisory management unit (SMU) 360. SMU 360 includes an output 362 to the shared KVM/USB devices and an output 364 for Ethernet Management.

In this example embodiment, each of blade servers 312-318 (four) comprise 8 blades disposed within a chassis. Each DMU module monitors the health of each of the blades and the chassis fans, voltage rails, and temperature of the server unit via communication lines 322A-328A. The DMU also controls the power supply functions of the blades in the chassis and switches between individual blades within the blade server chassis in response to a command from an input/output device (via communication lines 322B-328B). In addition, each of the DMU modules (332-338) is configured to control and monitor various blade functions and to arbitrate management communications to and from SMU 360 with respect to its designated blade server via a management bus 332A and an I/O bus 322B. Further, the DMU modules consolidate KVM/USB output and management signals into a single DVI type cable, which connects to SMU 360, and maintain a rotating log of events.

In this example embodiment, each blade of each blade servers includes an embedded microcontroller. The embedded microcontroller monitors health of the board, stores status on a rotating log, reports status when polled, sends alerts when problems arise, and accepts commands for various functions (such as power on, power off, Reset, KVM (keyboard, video and mouse) Select and KVM Release). The communication for these functions occurs via lines 322C-328C.

SMU 360 is configured to interface with the DMU modules in a star configuration at the management bus 342A and the I/O bus 342B connection, for example. SMU 360 communicates with the DMUs via commands transmitted via management connections to the DMUs. Management communications is handled via reliable packet communication over the shared bus with collision detection and retransmission capabilities. The SMU module is of the same physical shape as a DMU and contains an embedded DMU for its local chassis. The SMU communicates with the entire rack of four (4) chassis (blade server units) via commands sent to the DMUs over their management connections 342-348). The SMU provides a high-level user interface via the Ethernet port for the rack. The SMU switches and consolidates KVM/USB busses and passes them to the Shared KVM/USB output sockets.

Keyboard/Video/Mouse/USB (KVM/USB) switching between blades is conducted via a switched bus methodology. Selecting a first blade will cause a broadcast a signal on the backplane that releases all blades from the KVM/USB bus. All of the blades will receive the signal on the backplane and the previous blade engaged with the bus will electronically disengage. The selected blade will then electronically engage the communications bus.

A portion of the disclosure of this invention is subject to copyright protection. The copyright owner permits the facsimile reproduction of the disclosure of this invention as it appears in the Patent and Trademark Office files or records, but otherwise reserves all copyright rights.

Although the preferred embodiment of the automated system of the present invention has been described, it will be recognized that numerous changes and variations can be made and that the scope of the present invention is to be defined by the claims.

1. A system for remote booting of a server, comprising:
a client initiator, wherein said client initiator requests access to said server;
an iSCSI virtualizer, wherein said iSCSI virtualizer receives the access request;
an iSCSI initiator, wherein the iSCSI initiator acts upon the request received by said iSCSI virtualizer to initiate login to said server through use of an iSCSI Boot ROM on said server and to emulate a disk operating system through use of said iSCSI Boot ROM enabling said server to boot.

2. The system of claim 1, wherein said server boots in both a 16-bit mode and a subsequent 32-bit mode.

3. The system of claim 1, wherein said iSCSI Boot ROM appears as a local device upon completion of the server boot.

4. The system of claim 1, wherein said iSCSI virtualizer authenticates said login.

5. The system of claim 4, wherein said iSCSI virtualizer authenticates said login at least twice.

6. The system of claim 1, wherein said iSCSI virtualizer comprises a pair of replicated active directory service servers (ADSS).

7. A method for remote booting of a server:
receiving a request from an initiator to access the server;
initiating a boot of the server by powering on the server based upon the request;
intercepting the initiated boot process with an iSCSI Boot ROM emulating a disk operating system with said iSCSI Boot ROM; and
enabling said server to boot completely based upon the emulation of the disk operating system.

8. The method of claim 7, wherein said step of enabling said server to boot completely further comprises enabling said server to boot completely through use of a 16-bit mode and a subsequent 32-bit mode.

9. The method of claim 7, further comprising the step of presenting said iSCSI Boot ROM as a local device upon completion of the server boot.

10. The method of claim 7, further comprising the step of authenticating a login to said server.

11. The method of claim 10, further comprising the step of authenticating said login to said server at least twice.

12. A system for remote booting of a server, comprising:
means for requesting access to said server;
means for receiving said access request;
means for acting upon said access request to initiate login to said server through use of an iSCSI Boot ROM that is existent upon said server and for emulating a disk operating system through use of said iSCSI Boot ROM enabling said server to boot.

13. The system of claim 12, wherein said server boots in both a 16-bit mode and a subsequent 32-bit mode.

14. The system of claim 12, wherein said iSCSI Boot ROM appears as a local device upon completion of the server boot.

15. The system of claim 12, wherein said means for receiving also for authenticating said login.

16. The system of claim 15, wherein said means for receiving for authenticating said login at least twice.

17. The system of claim 12, wherein said means for receiving includes a pair of replicated active directory service servers (ADSS).
